(19) United States
(12) Patent Application Publication
(10) Pub. No.: US 2008/0310638 A1
(43) Pub. Date: Dec. 18, 2008

(54) Storage Medium Processing Method, Storage Medium Processing Device, and Program

(75) Inventors: Akihiro Kasahara, Chiba (JP); Akira Miura, Kanagawa (JP); Hiroshi Suu, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, MINATO-KU (JP)

(21) Appl. No.: 11/572,553

(22) PCT Filed: Jun. 24, 2005
(86) PCT No.: PCT/JP05/11609

§ 371 Date: Feb. 14, 2007

(30) Foreign Application Priority Data
Jul. 30, 2004 (JP) 2004-223035

(51) Int. Cl. H04L 9/06

(52) U.S. Cl. 380/279

(57) ABSTRACT

A situation where accesses concentrate on a release day is eased. A user terminal 20 requests a license center unit 40 to deliver content data submitting medium identifier data IDm. The license center unit 40 confirms a sale-start time of the content data concerning the delivery request in the sale-start time database 47, and delivers the content data or the like to the user terminal when the sale-start time has elapsed.

### FIELD OF THE INVENTION

The present invention relates to a storage-medium processing method, a system, and a program, which enables a user terminal to acquire content data or the like from a license center unit, by online-connecting a storage medium conforming to a double key encryption scheme via a user terminal to the license center unit.

### BACKGROUND OF THE INVENTION

In recent years, with development of information society, a content data distribution system is widely used. In this system, the content data including electronic data such as a book, newspaper, music, or an moving pictures, is distributed to a user terminal, which enables browsing of content data in the user terminal.

However, since electric content data (heretofore, it is referred to as “content data”) can be copied easily, the electronic content data tends to induce illegal acts that disregard copyright. From a viewpoint of protecting content data from such an illegal act, content data is encrypted and recorded by the encryption key and is usually decoded at the time of reproducing.

Content data protection technologies like this include CPRM (Content Protection for Prerecorded Media) which uses a standardized encryption key scheme in SD audio, SD video, SD E-e-Publish (SD computer-assisted publishing) or the like (for example, refer to Nonpatent literature 1). The encryption-key scheme adapted in this Nonpatent literature 1 is an encryption single key scheme which enciphers a title key with a medium unique key. On the other hand, the encryption double key scheme in which the content key is doubly encrypted with the user key and the medium unique key is known (for example, refer to Nonpatent literature 2). This kind of encryption double key scheme is used in MQbic (registered trademark), for example.

FIG. 6 is a schematic diagram showing the configuration of the SD card and a user terminal corresponding to the encryption double key scheme adopted in Mqbic. An SD card SDq is an example of a secure storage medium which securely stores data. The SD card SDq has a system area 1, a hidden area 2, a protection area 3, a user data area 4, and an encryption/decryption unit 5, and the data is stored in each area 1-4.

In a SD card SDq like this, key management information MKB (Media Key Block) and the medium identifier IDm are stored in the system area 1. The medium unique key Kmu is stored in the hidden area 2. The encrypted user key Enc (Kmu, Ku) is stored in the protection area 3, and the encrypted content key data Enc (Ku, Kc) is stored in the user data area 4. The expression of Enc (A, B) means the data B encrypted with data A in this specification. Here, the user key Ku is encryption/decryption key to the content key Kc, and is used in common also to two or more encrypted content key data Enc (Ku, Kc1), Enc (Ku, Kc2) . . . . Moreover, the subscript q of the SD card SDq denotes that it conforms to MQbic (registered trademark).

Here, the system area 1 is a read-only area which can be accessed from outside of the SD card. The hidden area 2 is a read-only area that the SD card itself refers to, and cannot be accessed at all from external. The protection area 3 is an area in which data read and write is possible from external of the SD card when authentication is accomplished.

The user data area 4 is an area in which read/writing is freely possible from outside of the SD card. The encryption/decryption unit 5 performs authentication, key exchanging, and cryptography, and has a function of encryption/decryption.

The user terminal 20q for reproducing operates logically as follows to such the SD card SDq. That is, the user terminal 20q, performs MKB processing of the key management information MKB read from the system area 1 of the SD card SDq with the device key Kd set up beforehand (S1), to obtain a medium key Km. Next, the user terminal 20q carries out the hash processing of both the medium key Km and the medium identifier IDm read from the system area 1 of the SD card SDq (S2), and obtains the medium unique key Kmu.

Thereafter, the user terminal 20q performs, based on the medium unique key Kmu, an authentication process and a key exchanging process (AKE: Authentication Key Exchange) with the decryption/encryption unit 5 of the SD card SDq, to share a session key with the SD card SDq (S3).

Note that the authentication and key exchanging process in the step S3 succeeds when the medium unique key Kmu in the hidden area 2 referred to at the decryption/encryption unit 5 coincides with the medium unique key Kmu generated by the user terminal 20q, thereby the session key Ks being shared.

Then, the user terminal 20q reads out the encrypted user key Enc (Kmu, Ku) from the protection area 3, through a cipher communication using the session key Ks (S4). This results in the encrypted user key Enc (Kmu, Ku) being decrypted by the medium unique key Kmu (S5). Then, the user key Ku will be obtained.

Finally, when the encrypted content key Enc (Ku, Kc) is read from the user data area 4 of the SD card SDq, the user terminal 20q carries out the decryption processing of the encrypted content key Enc (Ku, Kc) with the user key Ku to obtain a content key Kc (S5q). Finally, when the encrypted content data Enc (Kc, C) is read from Memory 11q, the user terminal 20q performs the decryption processing of the encrypted content data Enc (Kc, C) with the content key Kc (S6). Thereby, the user terminal 20q reproduces the obtained content data C.

Note that although the above-mentioned example stores encrypted content data in the memory 11q of the user terminal 20q, it may be stored in the external storage medium.

The above-mentioned encryption double key scheme stores encrypted content key data at the user data area 4 having a large memory capacitance compared to the protection area 3. Therefore, it has an advantage in that it can store a lot of encrypted content key data compared to encryption single key scheme.

Moreover, since the encryption double key scheme may store encrypted content data in the SD card, it may urge the distribution of encrypted content data.

Furthermore, in the encryption double key scheme, the medium identifier as an identifier is given to each SD card, and a unique user key is issued per medium identifier. This user key is also encrypted and stored in the protection area (protected area) of an SD card. Encryption of the user key depends on the medium identifier, and the user key can be decoded only with a authentic player. For this reason, content data cannot be acquired even if a trespasser copies only a content key unjustly from a user data area.

[Nonpatent literature 1] 4C An entity, LLC, [online], Internet <URL: http://www.4 Centity.com/, searched on Jun. 14, 2004>
[Nonpatent literature 2] IT information site and ITmedia news [online], Internet<URL:http://www.itmedia.co.jp/news/0307/18/njbt_{—}02. html, searched on Jun. 14, 2004>

### DISCLOSURE OF THE INVENTION

### Problem to be Solved

By the way, in a music content data or the like, since a release day is usually noticed several weeks before at the latest. If it is popular content data, buyers usually rush into it on the release day. When selling such content data in such a content data distribution system, accesses to a server concentrate on the release day, and chances that the server goes down becomes large. Moreover, an access time to the server and a download time may be longer for buyers.

### SUMMARY OF THE INVENTION

A storage medium processing method according to the present invention uses a storage medium and a user terminal. The storage medium stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data. The user terminal retains encrypted content data in which content data is encrypted so that it may be decrypted using the content key data, and the user terminal connected to the storage medium is enabled to access to a license center to obtain various kinds of data. The method comprises: a delivery request step in which the user terminal requests to the license center a delivery of the content data desired to be delivered before the sale of the content data is started, submitting the medium identifier data; a sale-start time referring step in which the license center refers to a sale-start time of the content data that the user terminal wants delivery thereof; and a delivery step delivering either the content data or the content key data thereof that the user terminal wants delivery thereof, when the sale-start time has elapsed.

A storage medium processing device according to the present invention is connected to a storage medium which stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data. This device performs data processing of the storage medium via a user terminal retaining encrypted content data in which content data is encrypted so that it may be decrypted using the content key data. The device comprises: a receiving unit receiving from the user terminal a delivery request of content data accompanied by submission of the medium identifier data before the sale of the content data desired to be delivered is started, a delivering unit that refers to sale-start time data indicating a sale-start time of the content data concerning the delivery request, and delivers either content data or content key data thereof concerning the delivery request to the user terminal when the sale-start time has elapsed.

An storage medium processing program according to the present invention uses a storage medium and a user terminal. The storage medium stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data. The user terminal to which the storage medium is able to be connected retains encrypted content data in which content data is encrypted so that it may be decrypted using the content key data. The user terminal connected to the storage medium is enabled to access to a license center to obtain various kinds of data. The program is configured to perform: a delivery request step in which the user terminal requests to the license center a delivery of the content data desired to be delivered before the sale of the content data is started, submitting the medium identifier data; a sale-start time referring step in which the license center refers to a sale-start time of the content data that the user terminal wants delivery thereof; and a delivery step delivering either the content data or the content key data thereof that the user terminal wants delivery thereof, when the sale-start time has elapsed.

### THE ADVANTAGE OF THE INVENTION

According to the present invention, a user can request a delivery of content data before the time the sale starts. Therefore, access concentration to a license center on a release day can be alleviated. Moreover, since a user can also access a license center before a release day for purchases of the content data, he can shorten the access time, the download time, or the like, to obtain content data.

### EMBODIMENTS

Hereafter, embodiments of the present invention will now be described with reference to the drawings. FIG. 1 is a diagram showing the configuration of the storage-medium processing system relating to the embodiment of the present invention.

The same numerals are given to the same parts as FIG. 6, and detailed explanation is omitted for these parts. Different parts are hereafter mainly described.

Specifically, in the system of this embodiment, a user terminal 20, holding a SD card SDq freely attachable and detachable therein, is enabled to communicate through a network 30 to the license center unit 40. The network 30 includes the internet, as well as intranets in mobile telephones, such as an I mode (registered mark), Ezweb (registered mark) or the like.

The user terminal 20 is equipped with a memory 21, a download unit 22, an SD card processing unit 23, a control unit 25, and an E-mail control unit 26. For a user terminal 20, any arbitrary device may be used, if it is an electronic instrument holding an SD card SDq attachable and detachable therein, such as a personal computer, a portable cellular phone, or a portable information terminal (personal digital assistant).

The memory 21 is a memory area which may be read and written from another unit 22-25. For example, the encrypted content data Enc (Kc, C) is stored therein.

The download unit 22 is controlled by the control unit 25, and it has a function of downloading the encrypted content key data Kc and a user key Ku from the license center unit 40. For example, browser software or the like may be used therefor.

Moreover, the download unit 22 has a function of receiving an E-mail transmitted from the license center unit 40, and is given an original mail address Add.

The SD card processing unit 23 is controlled by the control unit 25, and has a function of authentication of the SD card SDq, a cipher communication, and reading/writing data stored in each of the areas 1, 3, and 4. The control unit 25 has usual computer functions and a function of controlling each of the unit 21-24 according to operation of a user.

The E-mail control unit 26 has a function of performing various kinds of control to an E-mail from the license center unit 40 received in the download unit 22.

The license center unit 40 is equipped with a key delivery server 41, a sale server 42, a medium identifier database 43, a user key database 44, a content key database 45, a mail address database 46, a sale-start time database 47, an authenticated content ID database 48, and a content database 49.

The key delivery server 41 receives from the user terminal 20 through a network 30 a request of transmitting a content data.

In this case, the key delivery server 41 has a function of transmitting to the user terminal 20 through a network 30 content key data Kc concerning the request.

The sale server 42 has a function of receiving a request of transmitting the content data from the user terminal 20, and has a function of transmitting it to the key delivery server 41.

The medium identifier database 43 holds the medium identifier data IDm which each SD card has. The user key database 44 stores the user key data Ku which each SD card has.

The content key database 45 holds the various content key data. The mail address database 46 stores the mail addresses Add given to the download unit 22 of the user terminal 20, as being related to the medium identifier data IDm of each SD card.

The sale-start time database 47 holds the data of when the each content data will go on sale. The authenticated content ID database 48 holds data of the content key issued according to the request of an SD card holder, as being related to the medium identifier data IDm of the SD card. The content database 49 holds content data.

The security module 51 is a unit that performs encryption/decryption processing of the user key Ku and the content key Kc, and is equipped with a management key obtaining unit 52, and a key encryption management unit 53.

The management key obtaining unit 52 holds the management key readable from the key delivery server 41.

The key encryption management unit 53 has a function of receiving a setup of a management key by the key delivery server 41, decoding the encrypted user key for management and the encrypted content key for management respectively, which are received from the key delivery server 41 based on the management key to obtain a user key and a content key, encrypting the content key and basic metadata with the user key, and transmitting to the delivery server 41 the encrypted content key (with basic metadata included therein) obtained and (additional) metadata such as a purchase date or the like.

Next, in the storage medium processing system constituted as mentioned above, the process in which the user terminal 20 accesses the license center unit 40, and purchases content data is explained with reference to FIG. 2. In this system, when each SD card SDq purchases the content data, it is necessary to acquire the user key data Ku from the license center unit 40 beforehand. In FIG. 2, explanation will be done assuming that the user key data Ku has been already obtained.

First, in the user terminal 20, the control unit 25 starts the download unit 22 under the operation of the user. Then, the download unit 22 applies for an advance purchase (booking a purchase) of the content data desired to be distributed, requests the download of the content data, and make a reservation of charge (S11).

The medium identifier data IDm of the SD card SDq and the mail address Add of the download unit 22 are attached to this request.

The sale server 42 transmits the encrypted content data Enc (Kc, C) encrypted by the corresponding content key data Kc to the user terminal 20 before the advent of the sale-start time (S12).

The encrypted content data Enc (Kc, C) received in the download unit 22 is transmitted to and stored in the memory 21.

The sale server 42 saves in the mail address database 46 the medium identifier data IDm and the mail address Add attached to download request (S13), and checks the sale-start time of the content data C transmitted in S12, referring to the sale-start time database 47 (S14). This sale-start time data provides the timing of the transmission in the mail transmission step (S25) which is described later.

Next, the sale server 42 requests the key delivery server 41 to transmit the encrypted content key data Enc (Ku, Kc) and the basic metadata (a content ID, a title, a maker, and others) of the content data (S15).

The key delivery server 41 reads, on receiving the request, the encrypted user key data for management stored for every medium identifier data IDm beforehand from user key database 44 (S16). Then, the encrypted content key data Kc for management and the basic metadata (the content ID, the title, the maker, and others) concerning the specified content ID are read from the content key database 45 (S17).

Thereafter, when the key delivery server 41 reads the management key from the management key obtaining unit 52 (S18), it sets this management key in the key encryption management unit 53 (S19), and transmits a request of encrypting the content key data Kc to the key encryption management unit 53 (S20). Note that this request of encrypting contains the encrypted user key for management, the encrypted content key data for management, and the basic metadata.

Based on the management key, the key encryption management unit 53 decodes the encrypted content key data for management, and gets the content key data Kc. Thereafter, the key encryption management unit 53 encrypts the content key data Kc and the basic metadata by the user key data Ku, and transmits to the key delivery server 41 the encrypted content key data Kc (basic metadata is included) and the metadata (it is additional) such as a purchase date (S21).

If the additional metadata is read (S22), the key delivery server 41 generates a SOAP (Simple Object Access Protocol) message for example, including the encrypted content key data Kc and the metadata (S23). The encrypted content key data Kc and the metadata are transmitted to the sale server 42 by the SOAP message (S24). Simultaneously, the key delivery server 41 reads the mail address Add of the user terminal 20 as a receiver, from the mail address database 46. And it transmits the mail address to the sale server 42 by the SOAP message similarly. Note that the SOAP message is an example of a message scheme. It is needless to say that it may be changed into other schemes.

The sale server 42 waits for advent of the sale-start time obtained from the sale-start time database 47, and transmits to the mail control unit 26 the encrypted content key data Kc received from the key delivery server 41 by attaching it to an E-mail (S25).

When receiving of this E-mail is confirmed (S26), the sale server 42 performs charge and settlement concerning the transmitted content data (S27). The E-mail control unit 26 requests the SD card processing unit 23 to save the received encrypted content key data Kc (S28).

On receiving the request, the SD card processing unit 23 stores the encrypted content key data Kc in the user data area 4.

In this way, according to the embodiment, the user can transmit a request of distributing content data desired to be distributed before advent of the sale-start time of the content data. Also in this embodiment, as shown for example in FIG. 3 (a), bias of accesses per time zone within 24 hours occurs as a matter of course (rather than the time zone between morning and evening, accesses concentrate on the time zone between night and midnight). However, if a long advance sale period (from when booking procedure starts—and until when the sale starts) is set as shown in FIG. 3(b), some small access concentration will be expected on the booking start date, and the accesses will be deconcentrated during the whole advance sale period.

Access concentration on the booking start date is expected to be considerably less, compared to access concentration on the first sale date when an advance sale period is not set up. Therefore, according to the embodiment, the chances of server breakdown by access concentration can be smaller, and a user can also shorten the access time and the download time greatly.

Next, second embodiments of the present invention will now be described with reference to FIG. 4.

Since the configuration of the whole storage medium processing system is the same as that of the first embodiment, a detailed explanation will be omitted.

This embodiment is different from the first embodiment in the following point. That is, in this embodiment, sending the encrypted content data C to the user terminal 20 from the license center unit 40 is not performed immediately after a step of offering booking a purchase (S31). It transmits the encrypted content data C by attaching it to an E-mail with the encrypted content key data Kc in S44, which corresponds to S25 of the first embodiment (in a word, after the advent of the sale-start date). Also in this embodiment, when the sale-start date confirmed at S33 comes in this S45, an E-mail is transmitted to the user terminal 20, just like the first embodiment. Since S32-S43 are the same as that of S13-S24 of the first embodiment, explanation will be omitted.

Next, third embodiment of the present invention is explained with reference to FIG. 5. Since the configuration of the whole storage medium processing system is the same as that of the first embodiment, detailed explanation will be omitted. Moreover, S51-S63 shown in FIG. 5 are the same as that of S31-S43 of the second embodiment.

This embodiment is the same as the second embodiment in that it does not send to the user terminal 20 from the license center unit 40 the encrypted content data C immediately after the step of offering booking a purchase (S31).

However, in this embodiment, when the encrypted content key data Kc is transmitted in S64, the encrypted content data C is not attached to an E-mail. Instead of this, the URL (Uniform Resource Locator) data of the sale server 42 in which the content data is stored is included in the header of the E-mail, and the E-mail is transmitted. The sale server 42 performs charge and clearance thereafter (S65).

On confirming the receipt of this E-mail, the E-mail control unit 26 activates the download unit 22 (S66), even if the user himself does not execute the browsing of the E-mail body. In addition, it accesses the sale server 42, by designating the URL data shown in the header of the E-mail, and requests a download of the content data (S67).

Since URL data is in the header of the E-mail instead of in the body, it is free from an attack of an E-mail containing virus. Furthermore, by adding specific identification data in the URL data, the mail control unit 26 does not malfunction even if it is attacked by an E-mail with falsified URL data.

The sale server 42 attaches the encrypted content data C to the E-mail, and transmits it toward the download unit 22 (S68). When receiving of this E-mail has been checked, the mail control unit 26 requests the SD card processing unit 23 to save the encrypted content key data Kc (S69). In response to this request the SD card processing unit 23 saves the encrypted content key data Kc in the user data area 4.

Note that the process described in each of above-mentioned embodiments can be implemented by a program which can make a computer perform the process. The program can be stored in a storage medium, such as magnetic disks (a floppy (registered trademark) disk, a hard disk, etc.), an optical disk (CD-ROM, DVD etc.), a magneto-optical disk (MO), and a semiconductor memory.

Moreover, as this storage medium, scheme for storing may be of any type, as long as it is a storage medium enabled to store a program, readable by a computer.

Moreover, operating system (OS) working on a computer based on an indication of the program installed in the computer from the storage medium, a database management software, and a middleware such as network software, can implement part of the processes for realizing the embodiments.

Furthermore, the storage medium in the present invention is not limited to the medium that is independent of a computer. It may be a storage medium that downloads the program transmitted by a local area network (LAN) or the Internet, etc., and stores or temporarily stores it.

Moreover, a storage medium is not limited to a single one. When the processes in the embodiments are performed by a plurality of media, the media are included in the storage medium according to the present invention. In addition, the medium configuration cay be any type.

Note that a computer in the present invention is configured to perform each process in the embodiments based on a program stored in a storage medium. It may have any configurations. For example, it may be a single device such as a personal computer, or a system having a plurality of network-connected computers.

Moreover, a computer in the present invention is not limited to a personal computer, but includes a operation processing device included in a information processing device, and a microcomputer. It includes devices or apparatuses that can realize the function of the present invention by a program.

Furthermore, in the above-described embodiments, the update history by the medium identifier shown at the time of the update request is referred. As addition to this, it is possible to refer to the medium identifier shown in the user registration database 48, and when the matching user registration does not exist, the update of a user key may be refused.

Note that the present invention is not limited to the above-described embodiments themselves. In a practice phase, their components can be modified and embodied, as long as it does not depart from the spirit thereof. Moreover, merging two or more proper components indicated by the above-mentioned embodiments can form various inventions. For example, some components may be deleted from all the components shown in the embodiments. Furthermore, the components employed in different embodiments may be combined suitably.

### BRIEF DESCRIPTION OF THE DRAWINGS

FIG. 1 is a diagram showing the configuration of the storage-medium processing system concerning the embodiment of the present invention.

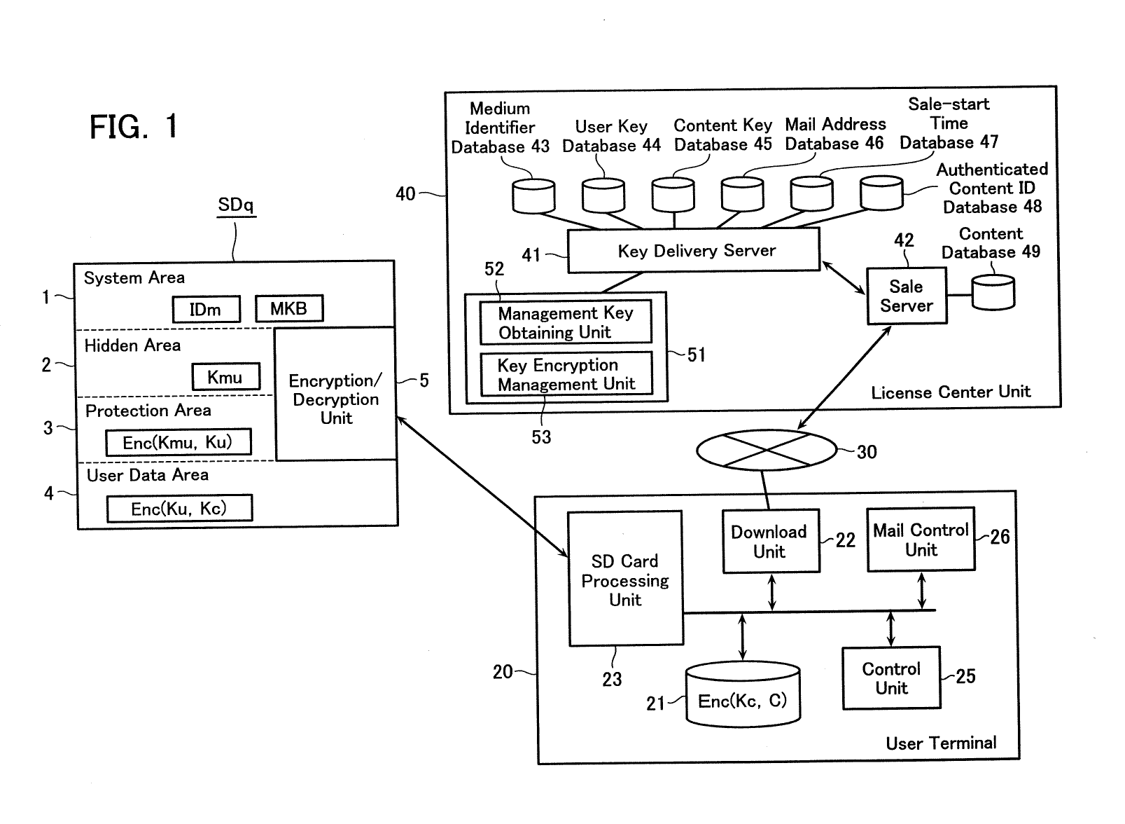

FIG. 2 illustrates a process in which the SD card SDq acquires the content key data through the user terminal 20.

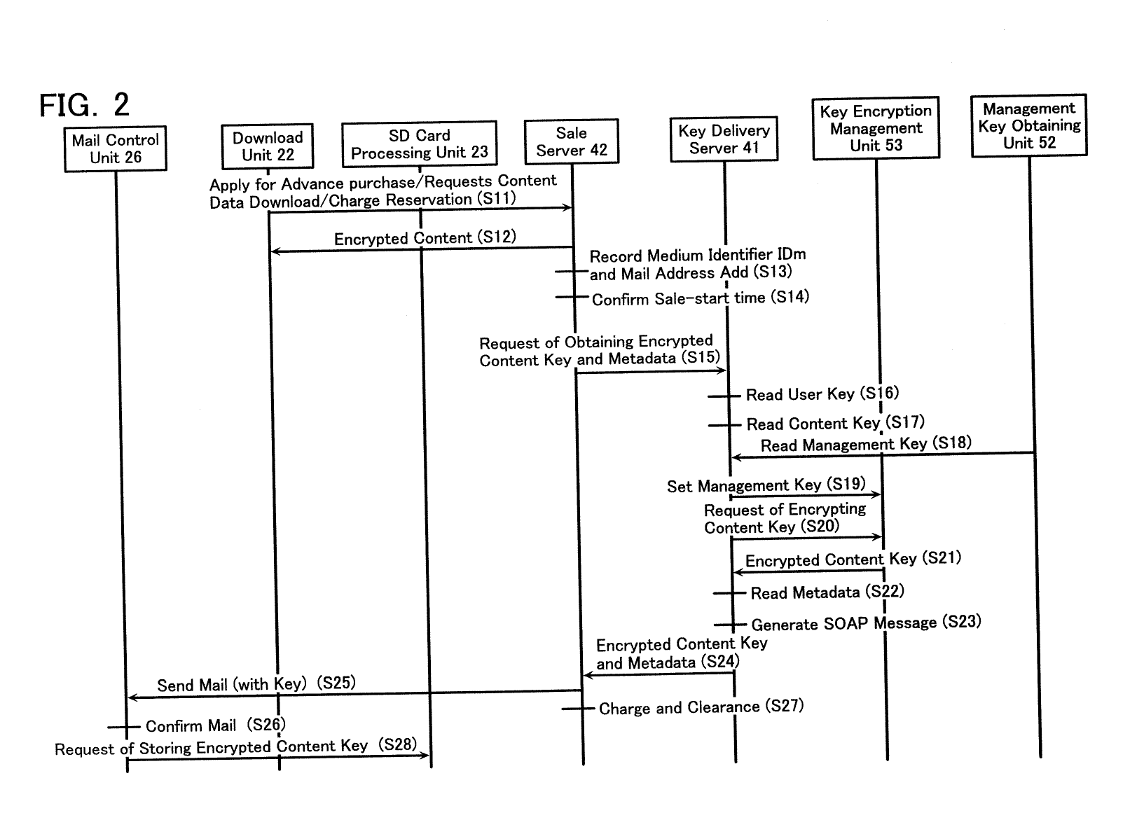

FIG. 3 shows an example of changes in number of accesses to a license center unit 40.

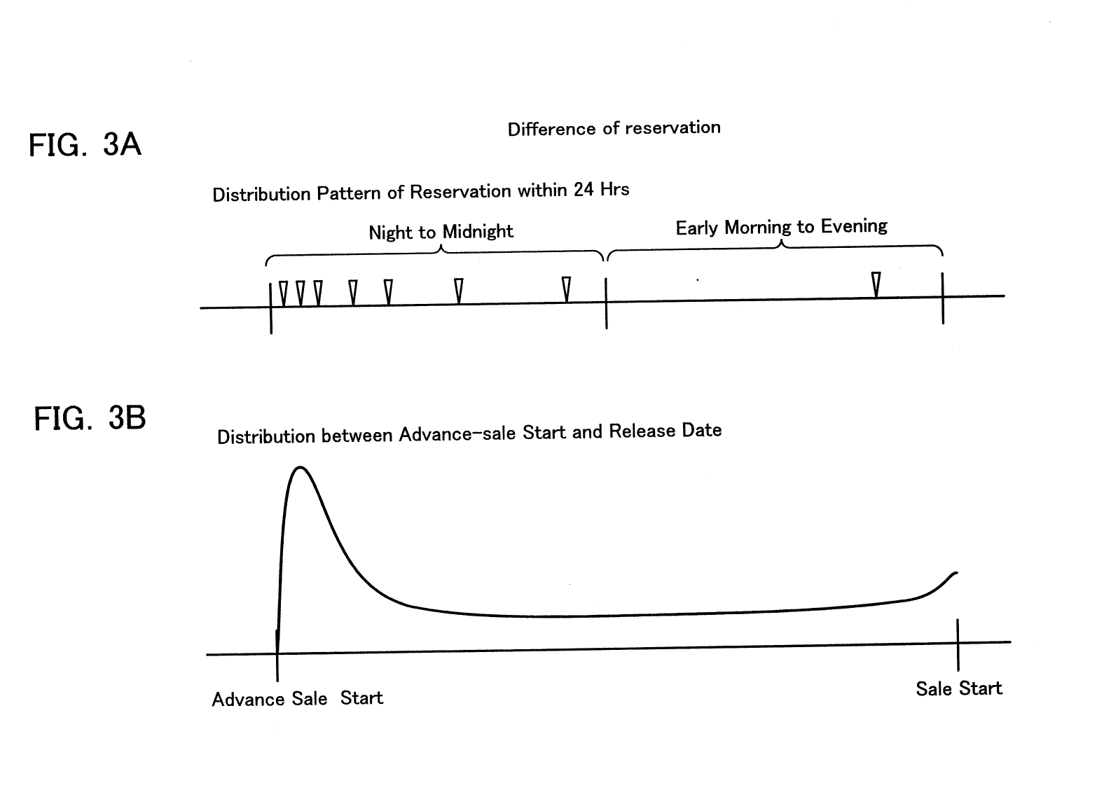

FIG. 4 shows an operation of the storage-medium processing system concerning the second embodiment of the present invention.

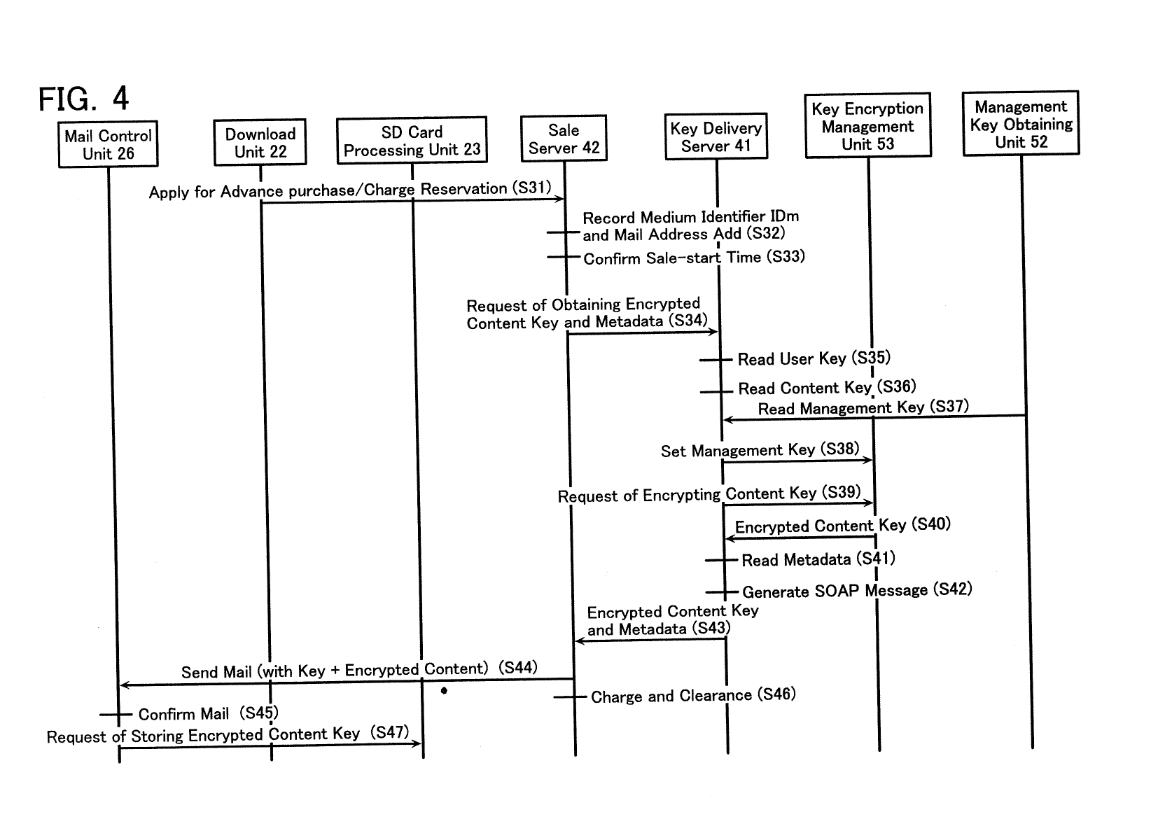

FIG. 5 shows an operation of the storage-medium processing system concerning the third embodiment of the present invention.

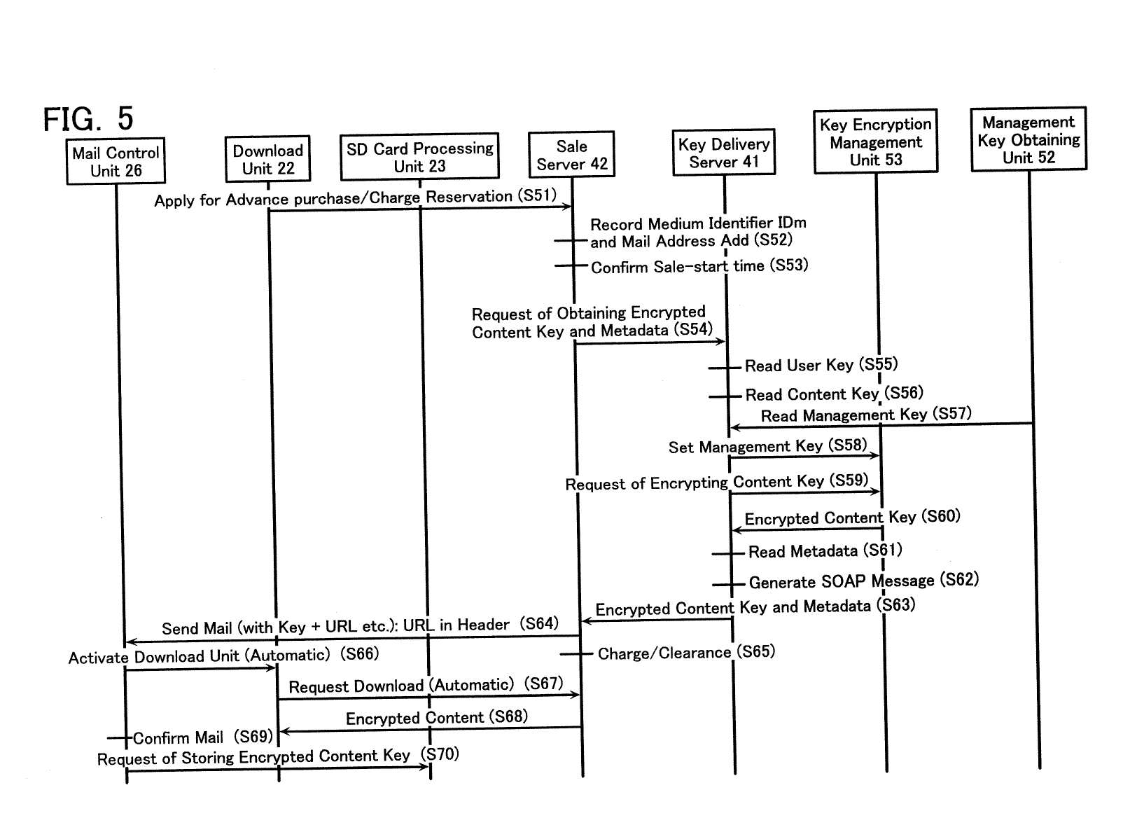

FIG. 6 is a diagram showing the configuration of an SD card corresponding to the encryption double key scheme, and a user terminal.

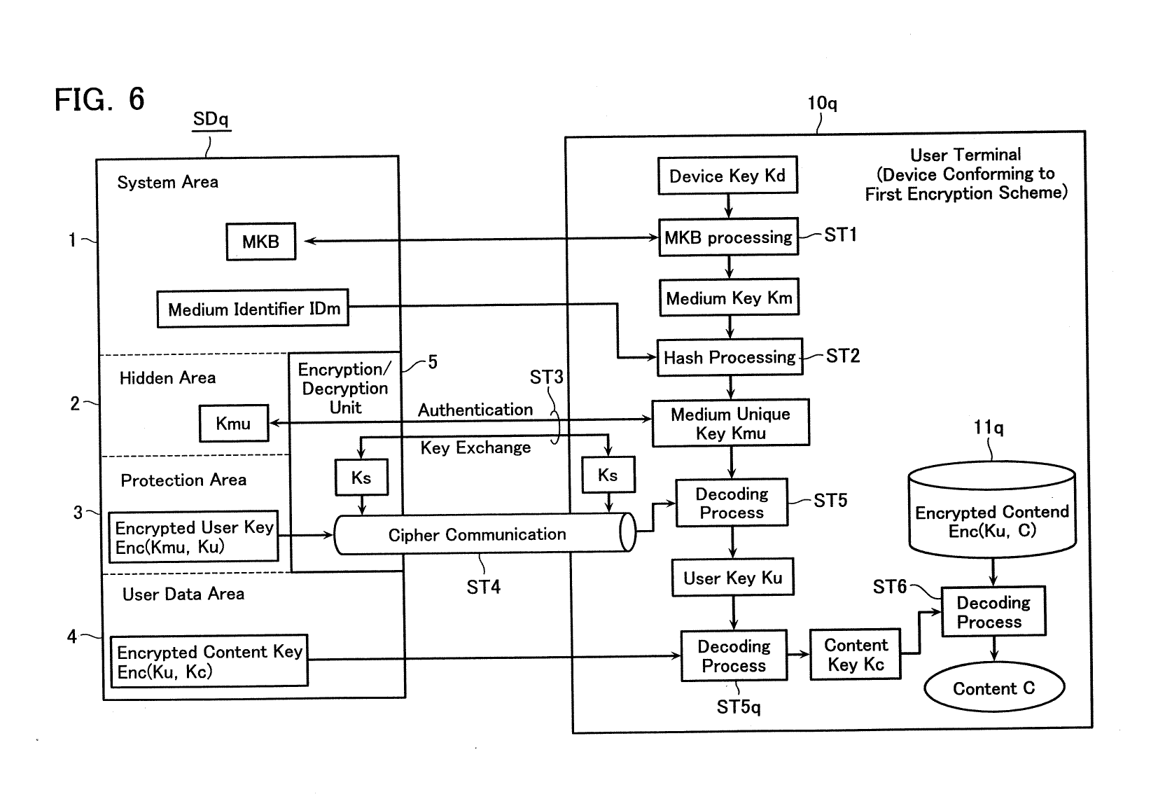

### AN EXPLANATION OF SYMBOLS

SDq . . . an SD card
1 . . . a system area
2 . . . a hidden area
3 . . . a protection area
4 . . . a user data area,
5 . . . a encryption/decryption unit
20 . . . a user terminal
21 . . . a memory
22 . . . a download unit
23 . . . a SD card processing unit
25 . . . a control unit
26 . . . an mail control unit
40 . . . a license center unit
41 . . . a key delivery server
42 . . . a sale server
43 . . . a medium key database
45 . . . a user key database
45 . . . a content key database
46 . . . an authenticated content ID database
51 . . . a security module
52 . . . a management key obtaining unit
53 . . . a key encryption management unit

1. A storage medium processing method a using a storage medium and a user terminal,
wherein the storage medium stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data,
the user terminal retains encrypted content data in which content data is encrypted so that it may be decrypted using the content key data, and
the user terminal connected to the storage medium is enabled to access to a license center to obtain various kinds of data,
the method comprising:
a delivery request step in which the user terminal requests to the license center a delivery of the content data desired to be delivered before the sale of the content data is started, submitting the medium identifier data;
a sale-start time referring step in which the license center refers to a sale-start time of the content data that the user terminal wants delivery thereof; and
a delivery step delivering either the content data or the content key data thereof that the user terminal wants delivery thereof, when the sale-start time has elapsed.

2. The storage medium processing method according to claim 1, wherein the delivery step encrypts the content data with the content key data and delivers the content data before the advent of the sale-start time, and delivers the content key data after the advent of the sale-start time.

3. The storage medium processing method according to claim 1, wherein the delivery step delivers the content data and the content key data after the advent of the sale-start time.

4. The storage medium processing method according to claim 1, wherein the delivery step delivers the content key data encrypted by the user key data after the advent of the sale-start time with URL data of a server holding corresponding content data.

5. The storage medium processing method according to claim 4, wherein the content key data is delivered by an E-mail, and the URL data is included in the header of the E-mail.

6. A storage medium processing device which is connected to a storage medium which stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data, and performs data processing of the storage medium via a user terminal retaining encrypted content data in which content data is encrypted so that it may be decrypted using the content key data, the device comprising:
a receiving unit receiving from the user terminal a delivery request of content data accompanied by submission of the medium identifier data before the sale of the content data desired to be delivered is started,
a delivering unit that refers to sale-start time data indicating a sale-start time of the content data concerning the delivery request, and delivers either content data or content key data thereof concerning the delivery request to the user terminal when the sale-start time has elapsed.

7. The storage medium processing device according to claim 6, wherein the delivering unit encrypts the content data with the content key data and delivers the content data before the advent of the sale-start time, and delivers the content key data after the advent of the sale-start time.

8. The storage medium processing device according to claim 6, wherein the delivering unit delivers the content data and the content key data after the advent of the sale-start time.

9. The storage medium processing device according to claim 6, wherein the delivering unit delivers the content key data encrypted by the user key data after the advent of the sale-start time with URL data of a server holding corresponding content data.

10. The storage medium processing device according to claim 5, wherein the content key data is delivered by an E-mail, and the URL data is included in the header of the E-mail.

11. An storage medium processing program using a storage medium and a user terminal,
wherein the storage medium stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data,
the user terminal to which the storage medium is able to be connected retains encrypted content data in which content data is encrypted so that it may be decrypted using the content key data, and
the user terminal connected to the storage medium is enabled to access to a license center to obtain various kinds of data,
the program is configured to perform:
a delivery request step in which the user terminal requests to the license center a delivery of the content data desired to be delivered before the sale of the content data is started,
submitting the medium identifier data;
a sale-start time referring step in which the license center refers to a sale-start time of the content data that the user terminal wants delivery thereof; and
a delivery step delivering either the content data or the content key data thereof that the user terminal wants delivery thereof, when the sale-start time has elapsed.
